(19) United States
(12) Patent Application Publication
(10) Pub. No.: US 2001/0020215 A1
(43) Pub. Date: Sep. 6, 2001

(54) Method for access to data containing location information as well as associated program and associated computer

(76) Inventors: Norbert Nopper, Villingen-Schwenningen (DE); Kurt Kammerer, Hufingen (DE)

Correspondence Address: BROMBERG & SUNSTEIN LLP, 125 SUMMER STREET, BOSTON, MA, 02110-1618, US

(21) Appl. No.: 09/768,799

(22) Filed: Jan. 24, 2001

(30) Foreign Application Priority Data
Jan. 25, 2000 (EP) 00101436.4

(51) Int. Cl. G06F 15/16

(52) U.S. Cl. 701/213; 709/217

(57) ABSTRACT

A system and method for access to data containing location information. From a terminal (10), a request is made for determining data (170). When processing the request by a search program (software agent) (S), the position of the terminal (10) is taken into account.

The present invention relates to a method for access to data containing location information, wherein a request for the determination of data is transmitted from a terminal to a computer of a data communications network, such as the Internet.

At present, data containing location information are accessed on the Internet for example by calling a Web page with the help of a data display program, also referred to as browser. For example, the Web page having the address http://www.cinema.de includes a directory of a plurality of cinemas in Germany. By entering the name of a city or town, it can be achieved that information only with regard to the cinemas of this particular city or town are displayed on the Web page.

The access method has the disadvantage that the location information is only taken into account after a large amount of information has already been transmitted to the terminal, which information is of no importance for the operator of this terminal.

Further, there are possibly also other Web pages on the Internet which contain information on cinemas which are not listed on the above-mentioned Web page, or on which short-term changes have been taken into account earlier than on the above-mentioned Web page. For the access to other Web pages, the operator would have to set up further connections.

It is the object of the invention to provide a simple method for access to data containing location information, in which method a large amount of data stored on the Internet is taken into account at low operation expense. Further, an associated program and an associated computer are to be provided.

The object concerning the method is solved by a method having the steps indicated in claim 1. Embodiments are provided in the subclaims.

The invention is based on the recognition that requests, during the processing of which data containing location information have to be accessed, mainly refer to location information which is directly related to the position of the terminal. Thus, the location information on the position of the terminal should automatically be considered when processing the request. Further, the invention is based on the recognition that data containing location information or data which are in close relation to location information, are stored on the Internet on a plurality of pages which can only be manually evaluated at a very high expense. In addition, the data are often changed. On the other hand, programs are known, which represent an operator in the network and automatically collect data for him, evaluate the data and even make decisions for him. Such programs are also referred to as software agents. The use of such programs in connection with data referring to location information opens up a variety of new possible applications.

In the method according to the invention a request for the determination of data is transmitted from a terminal to a computer of a data communications network, such as the Internet. In one embodiment of the invention a location information on the position of the terminal is included in the request, while it is otherwise determined in another embodiment. In the computer, instructions of a program are executed by a processor, which program has the function of a software agent. That means that the program automatically sets up connections to a plurality of service provisioning computers of the data communications network for the person making the request in order to determine data for the processing of the request. Dependent on the location information the program evaluates the data and generates a response which is transmitted to the terminal. Software agents are programs which independently perform tasks in a digital networked environment on behalf of the user, i.e. in this case on behalf of the operator of the terminal.

By means of the method according to the invention a response can be generated for which despite of a very low operation expense for an operator of the terminal data are taken into account which are stored on a plurality of Web pages in different service provisioning computers. The operator only has to enter his request into the terminal. The other steps can be carried out automatically. Taking into account the location information when processing the request by the software agent guarantees that the data collected by the software agent can be presorted dependent on the location information. The sorting key is predetermined on the terminal-side, namely by its position.

In one embodiment of the method according to the invention the position of the terminal changes after the request has been transmitted. On the basis of data included in the request a new location information is determined which is taken into account when evaluating the data by the software agent. For example, in addition to the location information the request further includes a direction in which the terminal moves. If the speed of movement is known or if the speed can be estimated then, by means of the equations for a uniform movement, it can easily be determined at which points of time the terminal will be at particular positions. By means of an additional information in the request on the point of time, the future position of the terminal for this particular point of time can be precalculated and the processing of the request can be directed to this future position.

Among other things, mobile radio phones and transportable computers having a mobile radio internet connection are used as mobile terminals. If the position of the terminal is entered by an operator, no technical devices have to be used for the determination of the position. Otherwise, the position of a mobile phone can be determined in an easy way and at low expense on the basis of the partitioning of the telecommunications network into small cells.

In another embodiment the data are stored in memories of the service provisioning computers according to a page description language, e.g. the page description language HTLM (Hyper Text Markup Language). For programming the software agent latest technologies are used, e.g. the programming language JAVA or JAVASCRIPT. These technologies have specially been developed for the Internet and thus also for the page description language HTLM.

In one embodiment a connection for transmitting the request is directly cleared after the request has been transmitted. Only after the processing of the request and the generating of the response a different connection for transmitting the response is set up. By using short messages, also referred to as short message service, for example connection fees can be saved.

In another embodiment, the terminal transmits data according to a protocol for the data transmission which protocol is also used in the data communications network. This protocol is, for example, the protocol TCP/IP (Transmission Control Protocol/Internet Protocol) used on the Internet. An example for such a terminal is a transportable computer having a mobile internet connection. Methods are also used in which the terminal transmits data according to a protocol which has been specially developed for mobile terminals on the basis of the protocol used in the data communications network, e.g. the protocol WAP (Wireless Application Protocol) for mobile radio devices.

Alternatively, terminals are used which transmit data according to a protocol which differs from the protocol determined for the data communications network. Thus, the terminal can be designed for the data transmission in a telephone network or in a mobile radio network. In this case, the terminal itself does not need an access to the data communications network. The separate set up of connections for the transmission of the request and for the response is especially useful if the use of the telephone network is more expensive than the use of a data communications network.

In one embodiment the location information is entered by an operator of the terminal via a keyboard or via a voice input unit.

The method according to the invention and its embodiments are used in one embodiment for requests which are mainly directed to the determination of location information. In particular in case of location information concerning the location of a gas station, a service area, an overnight accommodation, a cash machine or a customer service for vehicles, the expense for carrying out the method is justified since such information is required particularly often. In addition, requests with regard to this information are mainly made from terminals, the position of which is alongside a motorway or a highway. In particular, the expense for the program of the software agent is justified since data which have been collected once can be used again and again.

In one embodiment the automatic connections are set up after the transmission of the request. In this embodiment, databases which are present at some other location on the Internet are accessed. The creation of an own database in the memory of the computer in which the program for the determination of the data is executed, is no longer necessary. Consequently, no process steps for the creation and the update of an own data stock are required.

Further, the invention relates to a program for implementing the method according to the invention and its embodiments as well as a computer in which the program is stored. Thus, the effects mentioned above with regard to the method according to the invention and its embodiments also apply to the program and the computer.

In the following, an embodiment of the invention is explained with reference to the enclosed drawings.

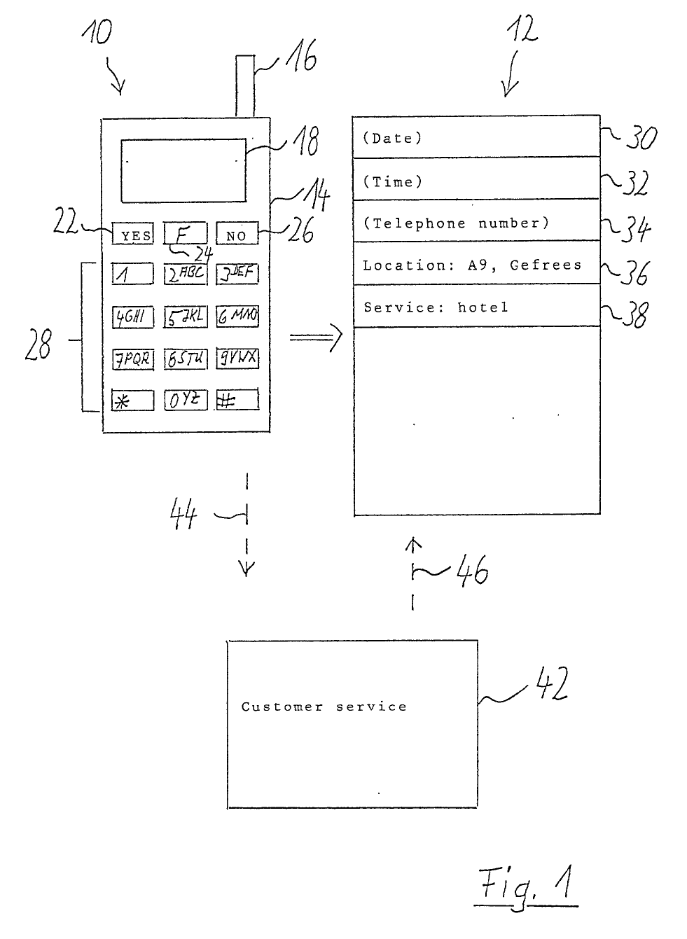

FIG. 1 shows a request for a search service entered from a mobile radio phone.

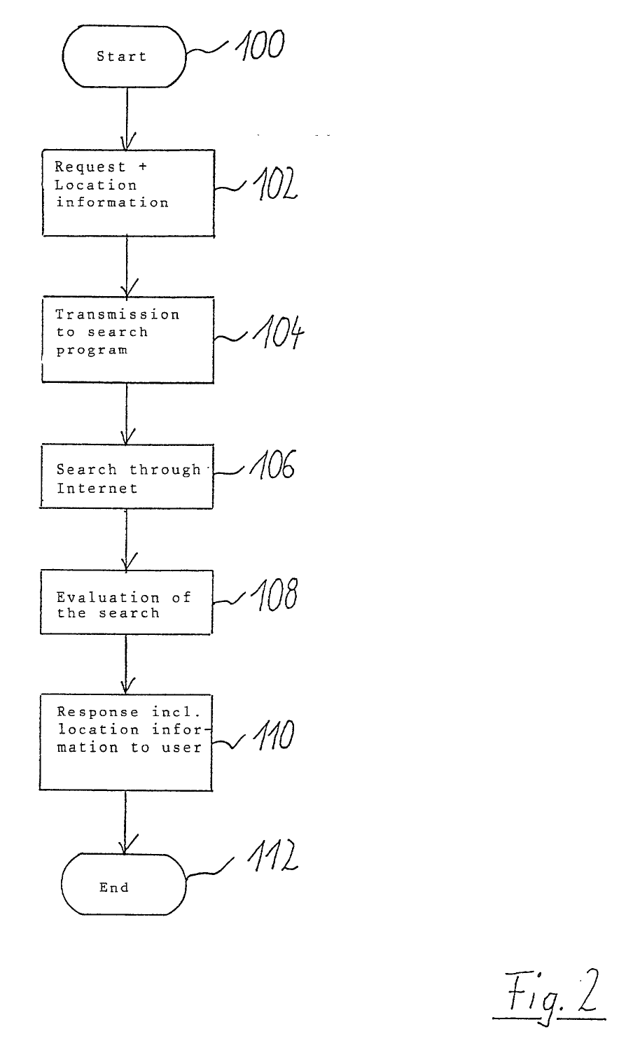

FIG. 2 shows a flowchart comprising the process steps for processing the request.

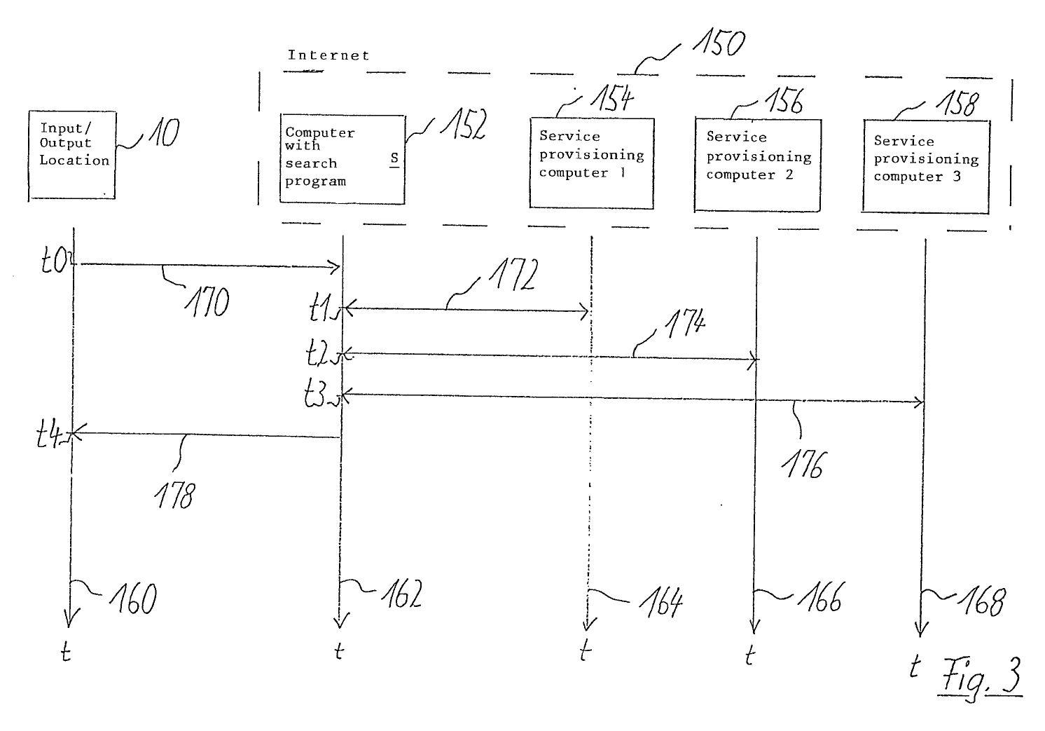

FIG. 3 shows the search for data on the Internet by using a search program.

FIG. 1 shows a mobile phone 10 with the aid of which a request 12 is generated. A housing 14 of the mobile phone 10 includes the electronic components and serves to receive an antenna 16 of a liquid crystal display, control keys 22 through 26 as well as keys of a numeric keypad 28.

On the liquid crystal display 18 several menu items are offered for selection dependent on the actuation of the control keys 22 through 26. Further, characters entered by means of the numeric keypad 28 are shown on the liquid crystal display 18.

The control keys 22 and 26 are used when accepting a call, when sending a call and when terminating the conversation. The control key 24 allows for calling several control menus. The keys of the numeric keypad serve to enter the numerals zero through nine as well as the letters of the alphabet.

In the following, it is assumed that an operator of the mobile phone 10 wishes to send a request to a search service in order to determine a hotel. With the help of the control key 24 a control menu is called which allows data to be entered for the data fields of the request 12.

The request 12 includes data fields 30 through 38. When generating the request 12, the current date is automatically entered into the data field 30. The current time is automatically stored in data field 32. In the data field 34, the telephone number is stored under which the mobile phone 10 can be reached. The operator enters his current position via the numeric keypad 28. It is assumed in this example that the operator and thus also the mobile phone 10 are on the motorway A9 near the exit “Gefrees”. The position information is stored in the data field 36. By means of the menu shown in the display 18 the operator is then invited to select a service. The selection comprises the search for a gas station, the search for a restaurant, the search for a hotel, the search for a cash machine and the search for a customer service for vehicles. The operator selects as service the search for a hotel. The service is registered in the data field 38.

In another embodiment the request 12 is generated by calling a customer service 42, see arrows 44 and 46. The operator calls the customer service 42 and transmits the data which are to be stored in the data fields 36 and 38 to an employee or to an automatic voice recognition system. The date and the time are also known to the customer service 42 so that corresponding data are entered into the request 12 without being previously transmitted. The telephone number is automatically transmitted to the customer service 42 by the mobile phone 10 and afterwards entered into the data field 34.

If the request 12 is directly generated by the mobile phone 10, a short message is sent for the transmission of the request 12, which short message is also referred to as “SMS message” (Short Message Service). The processing of the request is explained below with reference to the FIGS. 2 and 3.

In other embodiments the request 12 further comprises information on the direction in which the operator of the mobile phone 10 and thus also the mobile phone 10 itself move. The velocity of the movement is estimated, for example 100 km/h, or also entered by the operator or determined otherwise. Further, the request 12 comprises a time indication, such as two hours, which is taken into account when determining the future position of the mobile phone 10.

FIG. 2 shows a flowchart having the process steps for the processing of the request 12 so that in the following reference is also made to FIG. 1. The method starts with a step 100. In a next step 102 the request 12 is generated while entering inter alia the position of the mobile phone 10 into the data field 36.

In a step 104 the request 12 is transmitted from the mobile phone 10 to a search computer (software agent), which is operated by the service provider of the search service. The search program reads the data contained in the request 12 and starts the search on the Internet, see step 106. The search process is explained in more detail below with reference to FIG. 3.

In a step 108 the search program evaluates the search results. From the hotels determined in step 106 a hotel is selected which is as close as possible to the position of the terminal 10, i.e. as close as possible to the location indicated in the data field 36. Furthermore, by means of inquiring the page of this hotel it is automatically checked whether guests can still be taken in. If this is the case the hotel is selected. Otherwise a hotel is searched which is further away and still offers overnight accommodations.

In a step 110 the address of the hotel selected in step 108 is entered into a response message which is transmitted from the search computer to the mobile phone 10.

In a step 112 the method is terminated. When receiving a short message, the address of the hotel, for example the city or town, street and house number, is shown on the display 18 of the mobile phone 10.

FIG. 3 shows the search for data on the Internet 150. The Internet 150 is an interconnection of many data networks by means of which several computers are connected each, from which computers 152 through 158 are illustrated in FIG. 3.

In FIG. 3 time axes 160 through 168 extending in the transverse direction of the sheet are shown on which the time t is marked. The time axis 160 relates to operations in the terminal 10. The time axes 162, 164, 166 and 168 relate to operations in the computers 152, 154, 156 and 158, respectively. Equal points of time are on a straight line extending in the longitudinal direction of the sheet. Later points of time are closer to the lower edge of the sheet than earlier points of time.

The transmission of the request 12 from the mobile phone 10 to the computer 152 at a point of time t0 is illustrated by an arrow 170. The request 12 is transferred by a transmission unit (not shown) between the mobile radio network and the Internet 150.

The computer 152 includes a processor and a memory unit in which the instructions of the search program are stored. The search program S automatically collects data in the Internet 150, filters the data according to predetermined criteria and independently makes decisions. The search program S is also referred to as software agent. When executing the search program S, the computer 152 is successively connected with the computers 154, 156 and 158 at the points of time t1, t2 and t3, see double arrows 172 through 176. Web pages which contain data with regard to hotels near the motorway A9 are stored in memory units of the computers 154, 156 and 158. For example, in the computer 154 the Web page of a hotel agency for the whole of Germany is stored. The computer 156 includes the Web pages of several hotels which are alongside the motorway A9. In the computer 158 the Web page of a tourism association is stored. The addresses of the computers 154, 156 and 158 are determined independently by the search program 152 by means of inquiring search machines with regard to the search term “hotel”. Further, in another embodiment the addresses of the computers are given to the search program.

The search program S searches databases of other providers in the computers 154, 156 and 158. These databases are for example Oracle data bases. The software agent automatically identifies the format of the database and accesses the data of the database according to this format. The computer 152 has no database so that the operator of the search program S does not have to provide and update data, either.

Between the point of time t3 and the point of time t4, the search program S evaluates the data which have been transmitted from the computers 154 through 158, see also FIG. 2, step 108. At the point of time t4, the response including the location information with regard to the selected hotel is transmitted from the computer 152 to the mobile phone 10, see arrow 178.

As software agents stationary agents, i.e. programs which are exclusively executed in the computer 152, are used as well as so-called mobile agents, which are only started in the computer 152 and afterwards executed in the computers 154, 156 and 158.

### List of Reference Numerals

| | |
|---|---|
| 10 | mobile phone |
| 12 | request |
| 14 | housing |
| 16 | antenna |
| 18 | liquid crystal display |
| 22 through 26 | control keys |
| 28 | numeric keypad |
| 30 through 38 | data field |
| 42 | customer service |
| 44, 46 | arrow |
| 100 | start |
| 102 | request and location information |
| 104 | transmission to search program |
| 106 | search through Internet |
| 108 | evaluation of the search |
| 110 | response with location information to user |
| 112 | end |
| 150 | Internet |
| 152 through 158 | computer |
| 160 through 168 | time axis |
| 170 | arrow |
| 172 through 176 | double arrow |
| t0 through t4 | point of time |
| 178 | arrow |
| S | search program |

We claim:

1. A method for access to data containing location information, the method comprising:
receiving a request for a determination of data, the request being sent from a terminal to a computer connected to a data communications network;
determining the position of the requesting terminal;
setting up connections with one or more service provisioning computers of the data communications network;
processing the request at the one or more service provisioning computers;
evaluating the processed request based on the determined position of the requesting terminal;
generating a response based on the evaluation, the response including data containing location information related to the position of the requesting terminal; and
transmitting the response to the requesting terminal.

2. The method according to claim 1, further comprising:
receiving information for determining the position of the requesting terminal subsequent to the process for receiving the request and prior to the process for determining the position of the requesting terminal.

3. The method according to claim 1 wherein the received request includes information for determining the position of the requesting terminal.

4. The method according to claim 1 wherein the process for determining the position of the requesting terminal includes determining the position of the requesting terminal based on the location of the requesting terminal in a telecommunications network.

5. The method according to claim 1 wherein the position of the requesting terminal changes subsequent to the process for receiving the request.

6. The method according to claim 5 wherein the new position of the requesting terminal is determined from data contained in the received request.

7. The method according to claim 5 wherein the new position of the requesting terminal is determined based on the location of the requesting terminal in a telecommunications network.

8. The method according to claim 5, further comprising:
receiving information for determining the new position of the requesting terminal subsequent to the process for receiving the request and prior to the process for determining the position of the requesting terminal.

9. The method according to claim 1 wherein the one or more service provisioning computers stores data in accordance with a page description language.

10. The method according to claim 9 wherein the page description language is Hyper Text Markup Language.

11. The method according to claim 1, further comprising:
terminating communication between the computer and the terminal subsequent to the process for receiving the request; and
setting up new communication between the computer and the terminal subsequent to the process for generating the response.

12. The method according to claim 1 wherein the received request is transmitted in accordance with a data transmission protocol for the data communications network.

13. The method according to claim 12 wherein the data transmission protocol is Transport Control Protocol/Internet Protocol.

14. The method according to claim 1 wherein the received request is transmitted in accordance with a protocol different from a predetermined data transmission protocol for the data communications network.

15. The method according to claim 14 wherein the data transmission protocol is Wireless Application Protocol.

16. The method according to claim 1 wherein the location information is L, wherein L is the location of a gas station, the location of a service area, the location of an overnight accommodation, or the location of a customer service for vehicles.

17. The method according to claim 1 wherein the process for setting up connections between the computer and one or more service provisioning computers of the data communications network occurs subsequent to the process for receiving the request.

18. A system for access to data containing location information, the system comprising:
means for receiving a request for a determination of data, the request being sent from a terminal to a computer connected to a data communications network;
means for determining the position of the requesting terminal;
means for setting up connections with one or more service provisioning computers of the data communications network;
means for processing the request at the one or more service provisioning computers;
means for evaluating the processed request based on the determined position of the requesting terminal;
means for generating a response based on the evaluation, the response including data containing location information related to the position of the requesting terminal; and
means for transmitting the response to the requesting terminal.

19. The system according to claim 18, further comprising:
means for receiving information for determining the position of the requesting terminal subsequent to receiving the request and prior to determining the position of the requesting terminal.

20. The system according to claim 18 wherein the received request includes information for determining the position of the requesting terminal.

21. The system according to claim 18 wherein the means for determining the position of the requesting terminal includes determining the position of the requesting terminal based on the location of the requesting terminal in a telecommunications network.

22. The system according to claim 18 wherein the position of the requesting terminal changes subsequent to receiving the request.

23. The system according to claim 22 wherein the new position of the requesting terminal is determined from data contained in the received request.

24. The system according to claim 22 wherein the new position of the requesting terminal is determined based on the location of the requesting terminal in a telecommunications network.

25. The system according to claim 22, further comprising:
means for receiving information for determining the new position of the requesting terminal subsequent to receiving the request and prior to determining the position of the requesting terminal.

26. A computer program product for access to data containing location information, the computer program product comprising a computer readable medium having a computer readable program code thereon, the computer program code comprising:
program code for receiving a request for a determination of data, the request being sent from a terminal to a computer connected to a data communications network;
program code for determining the position of the requesting terminal;
program code for setting up connections with one or more service provisioning computers of the data communications network;
program code for processing the request at the one or more service provisioning computers;
program code for evaluating the processed request based on the determined position of the requesting terminal;
program code for generating a response based on the evaluation, the response including data containing location information related to the position of the requesting terminal; and
program code for transmitting the response to the requesting terminal.

27. The computer program product according to claim 26, further comprising:
program code for receiving information for determining the position of the requesting terminal subsequent to receiving the request and prior to determining the position of the requesting terminal.

28. The computer program product according to claim 26 wherein the received request includes information for determining the position of the requesting terminal.

29. The computer program product according to claim 26 wherein the computer program code for determining the position of the requesting terminal includes determining the position of the requesting terminal based on the location of the requesting terminal in a telecommunications network.

30. The computer program product according to claim 26 wherein the position of the requesting terminal changes subsequent to receiving the request.

31. The computer program product according to claim 30 wherein the new position of the requesting terminal is determined from data contained in the received request.

32. The computer program product according to claim 30 wherein the new position of the requesting terminal is determined based on the location of the requesting terminal in a telecommunications network.

33. The computer program product according to claim 30, further comprising:
program code for receiving information for determining the new position of the requesting terminal subsequent to receiving the request and prior to determining the position of the requesting terminal.
